(19) United States
(12) Patent Application Publication
(10) Pub. No.: US 2020/0108669 A1
(43) Pub. Date: Apr. 9, 2020

(54) TIRE

(71) Applicant: Toyo Tire Corporation, Itami-shi (JP)

(72) Inventor: Masashi NAKAMURA, Itami-shi (JP)

(73) Assignee: Toyo Tire Corporation, Itami-shi (JP)

(21) Appl. No.: 16/587,326

(22) Filed: Sep. 30, 2019

(30) Foreign Application Priority Data
Oct. 3, 2018 (JP) 2018-188139

(51) Int. Cl. B60C 19/00; B60C 11/00

(52) U.S. Cl. CPC B60C 19/00; B60C 2019/004; B60C 11/005

(57) ABSTRACT

In a tire in which an electronic component is embedded, the electronic component is embedded at a position overlapping, in a tire-radial direction, with a main groove extending in a circumferential direction of an annular tread rubber, which extends in the circumferential direction of the tire.

### CROSS-REFERENCE TO RELATED APPLICATIONS

This application is based on and claims the benefit of priority from Japanese Patent Application No. 2018-188139, filed on 3 Oct. 2018, the content of which is incorporated herein by reference.

### FIELD

The present invention relates to a tire in which an electronic component is embedded.

### BACKGROUND

Conventionally, tires in which an electric component such as RFID tag is embedded within the rubber structure have been known. With such tires, by an RFID tag embedded in the tire and a reader as an external device carrying out communication, it is possible to perform production control of tires, usage history management, etc.

For example, Japanese Unexamined Patent Application (Translation of PCT Application), Publication No. 2018-505088 discloses a tire arranging an RFID tag between at least two of a plurality of layers of tread.

Japanese Unexamined Patent Application, Publication No. 2004-148953 discloses a tire including a carcass consisting of at least one ply extending toroidally over a pair of beads, a pair of side walls and the tread (crown part); and an inner liner consisting of at least two sheets of air impermeable rubber of an inner layer rubber and outer layer rubber arranged at an inner circumferential side of the carcass, in which the electronic chip is arranged between the inner/outer layer rubber constituting the inner liner, and includes a display part which can identify a tire-circumferential direction arranging position of the electronic chip at the outer surface position of the tire corresponding to the arranging position of the electronic chip.

### SUMMARY

Herein, in Patent Document 1 and Patent Document 2, since the receiving (transceiving) work/operation becomes easy in the case of the tires being piled up, etc., it shows embedding an electronic component such as an RFID tag in the tread forming the contact patch with the road surface.

However, since great load and great warping occurs at the tread forming the contact patch with the road surface, it is difficult to maintain the durability of an electronic component such as an RFID tag, and in the case of embedding the electronic component at a deep part on an inner side in the tire-radial direction of the tread in order to avoid damage of the electronic component, there have been inconveniences such as becoming difficult to maintain favorable communication performance (reception range).

The present invention has been made taking account of the above-mentioned problem, and an object thereof is to provide a tire enabling to maintain the durability and communicability of an electronic component, even in a case of arranging the electronic component in the tread.

A tire (for example, the tire 1) according to a first aspect of the present invention includes an electronic component which is embedded at a position overlapping in a tire-radial direction with a main groove (for example, the main groove 12a) extending in a circumferential direction of an annular tread rubber (for example, the tread rubber 28), which extends in a circumferential direction of the tire.

According to a second aspect of the present invention, in the tire (for example, the tire 1) as described in the first aspect, the electronic component may be disposed at an interface (for example, the interface 28c) between a tread cap (for example, the tread cap 28b) and a tread base (for example, the tread base 28a) constituting the tread rubber.

According to a third aspect of the present invention, in the tire (for example, the tire 1) as described in the first or second aspect, the electronic component may be embedded in the tread rubber so as to overlap in a tire-radial direction with a protrusion (for example, the tread wear indicator 12b, stone ejector 12c) provided at a groove bottom of the main groove.

According to the present invention, it is possible to provide a tire enabling to maintain the durability and communicability of an electronic component, even in a case of arranging the electronic component in the tread.

### BRIEF DESCRIPTION OF THE DRAWINGS

FIG. 1 is a view showing a half section in a tire-width direction of a tire according to an embodiment of the present invention;

FIG. 2A is a view showing an RFID tag protected by a protective member, in a tire according to a second embodiment of the present invention;

FIG. 2B is a view showing a cross section along the line b-b in FIG. 2A;

FIG. 2C is a view showing a cross section along the line c-c in FIG. 2A;

FIG. 3 is a half section showing a tread pattern of the tire according to an embodiment of the present invention;

FIG. 4 is a partial cross-sectional view showing the tire according to an embodiment of the present invention in FIG. 3;

FIG. 5 is a half section showing the tread pattern of the tire according to an embodiment of the present invention; and

FIG. 6 is a partial cross-sectional view showing a tire according to an embodiment of the present invention in FIG. 5.

### DETAILED DESCRIPTION OF THE INVENTION

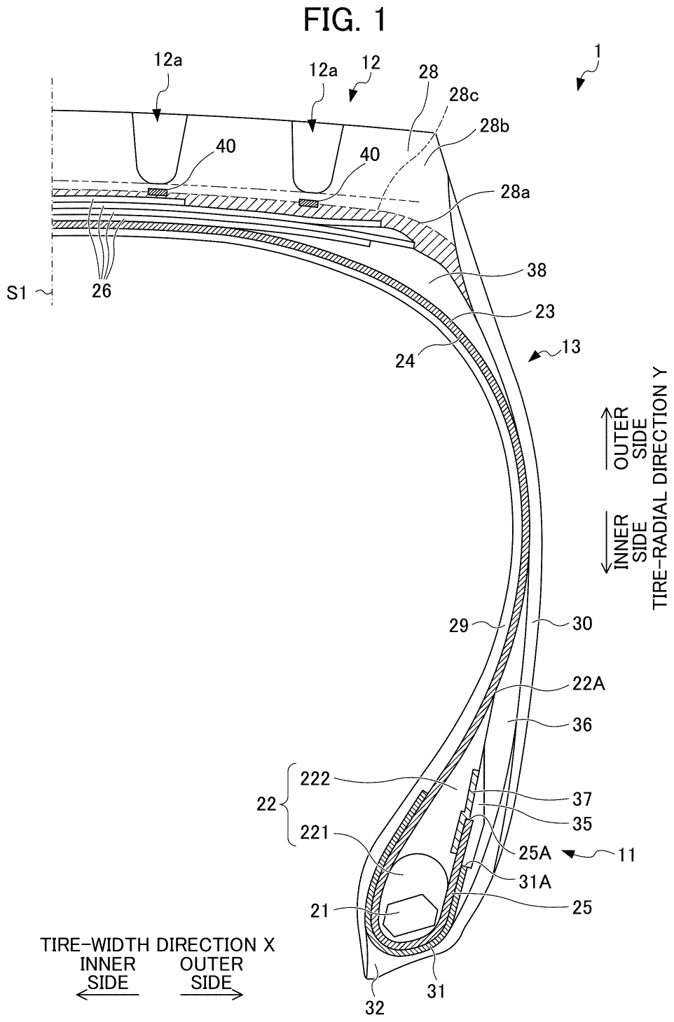

Hereinafter, an embodiment of the present invention will be explained while referencing the drawings. FIG. 1 is a view showing a half section in a tire-width direction of a tire 1 according to the present embodiment. The basic structure of the tire is left/right symmetric in the cross section of the tire-width direction; therefore, a cross-sectional view of the right half is shown herein. In the drawings, the reference symbol S1 is the tire equatorial plane. The tire equatorial plane S1 is a plane orthogonal to the tire rotation axis, and is positioned in the center of the tire-width direction. Herein, tire-width direction is a direction parallel to the tire rotation axis, and is the left/right direction of the paper plane of the cross-sectional view in FIG. 1. In FIG. 1, it is illustrated as the tire-width direction X. Then, inner-side of tire-width direction is a direction approaching the tire equatorial plane S1, and is the left side of the paper plane in FIG. 1. Outer side of tire-width direction is a direction distancing from the tire equatorial plane S1, and is the right side of the paper plane in FIG. 1. In addition, tire-radial direction is a direction perpendicular to the tire rotation axis, and is the vertical direction in the paper plane of FIG. 1. In FIG. 1, it is illustrated as the tire-radial direction Y. Then, outer-side of tire-radial direction is a direction distancing from the tire rotation axis, and is the upper side of the paper plane in FIG. 1. Inner-side of tire-radial direction is a direction approaching the tire rotation axis, and is the lower side of the paper plane in FIG. 1. The same also applies to FIGS. 4 and 6.

The tire 1 is a tire for heavy loads used in trucks, buses, etc., for example, and includes a pair of beads 11 provided at both sides in the tire width direction, tread 12 forming a contact patch with the road surface, and a pair of sidewalls 13 which extends between the pair of beads and the tread 12, as shown in FIG. 1.

The bead 11 includes an annular bead core 21 formed by wrapping around several times bead wires made of metal coated with rubber, and a bead filler 22 of tapered shape extending to the outer side in the tire-radial direction of the bead core 21. The bead filler 22 is configured by a first bead filler 221 which covers the outer circumference of the bead core 21, and a second bead filler 222 which is arranged on the outer side in the tire-radial direction of the first bead filler 221.

The second bead filler 222 is configured from rubber with a modulus higher than an inner liner 29 and side wall rubber 30 described later. Then, the first bead filler 221 is configured from rubber of an even higher modulus than the second bead filler 222. It should be noted that the first bead filler 221 may be a form not covering the outer circumference of the bead core 21, if at least a part thereof is arranged on the outer side in the tire-radial direction of the bead core 21. In addition, the bead filler 22 may be formed from rubber of one type. In other words, it may not necessarily be divided into the first bead filler 221 and second bead filler 222.

The bead core 21 is a member which plays a role of fixing a tire filled with air to the rim of a wheel which is not illustrated. The bead filler 22 is a member provided in order to raise the rigidity of the bead peripheral part and to ensure high maneuverability and stability.

A carcass ply 23 constituting a ply serving as the skeleton of the tire is embedded inside of the tire 1. The carcass ply 23 extends from one bead core to the other bead core. In other words, it is embedded in the tire 1 between the pair of bead cores 21, in a form passing through the pair of side walls 13 and the tread 12.

The carcass ply 23 includes a ply body 24 which extends from one bead core to the other bead core, and extends between the tread 12 and bead 11, and a ply folding part 25 which is folded around the bead core 21. Herein, a folding end 25A of the ply folding part 25 is positioned more to an inner side in the tire-radial direction than a tire-radial direction outside end 22A of the bead filler 22.

The carcass ply 23 is configured by a plurality of ply cords extending in a tire-width direction. In addition, a plurality of ply cords is arranged side by side in a tire circumferential direction. This ply cord is configured by a metal steel cord, or an insulated organic fiber cord such as polyester or polyamide, or the like, and is covered by rubber.

In the tread 12, a plurality of layers of steel belts 26 is provided in the outer side in the tire radial direction of the carcass ply 23. The steel belt 26 is configured by a plurality of steel cords covered by rubber. By providing the steel belts 26, the rigidity of the tire is ensured, and the contact state of the road surface with the tread 12 improves. In the present embodiment, although four layers of steel belts 26 are provided, the number of layered steel belt 26 is not limited thereto.

The tread rubber 28 is provided at the outer side in the tire-radial direction of the steel belt 26. A tread pattern (tread/main groove 12a in FIG. 1) is provided to the outer surface of the tread rubber 28, and this outer surface serves as a contact surface which contacts with the road surface. In more detail, a main groove 12a extending in the circumferential direction is provided to an outer surface of the tread rubber 28 in the annular tread 12 extending in the circumferential direction of the tire.

In the vicinity of the outer side in the tire-width direction of the tread 12, in a region between the carcass ply 23, and the steel belts 26/tread rubber 28, a shoulder pad 38 is provided. This shoulder pad 38 extends until a region of the outer side in the tire-radial direction of the side wall 13, and part thereof forms an interface between side wall rubber 30 described later. In other words, in the region of the outer side in the tire radial direction of the side wall 13, a part of the shoulder pad 38 is present on the inner side in the tire width direction of the side wall rubber 30.

The shoulder pad 38 consists of a rubber member having cushioning, and exhibits a cushion function between the carcass ply 23 and steel belt 26. In addition, since the shoulder pad 38 consists of rubber having a characteristic of low heat buildup, it is possible to suppress heat generation effectively, by extending until the side wall 13.

In the bead 11, side wall 13 and tread 12, an inner liner 29 serving as a rubber layer constituting an inside wall surface of the tire 1 is provided to a tire inner cavity side of the carcass ply 23. The inner liner 29 is configured by air permeation resistant rubber, whereby the air inside the tire inner cavity is prevented from leaking to outside.

In the side wall 13, the side wall rubber 30 constituting the outer wall surface of the tire 1 is provided to the outer side in the tire-width direction of the carcass ply 23. This side wall rubber 30 is a portion which bends the most upon the tire exhibiting a cushioning action, and usually flexible rubber having fatigue resistance is adopted therein.

On the inner side in the tire radial direction of the carcass ply 23 provided around the bead core 21 of the bead 11, a steel chafer 31 serving as a reinforcement ply is provided so as to cover at least part of the carcass ply 23. The steel chafer 31 also extends to the outer side in the tire-width direction of the ply folding part 25 of the carcass ply 23, and an end part 31A of this steel chafer 31 is positioned more to the inner side in the tire-width direction than the folding end 25A of the ply folding part 25. This steel chafer 31 is a metal reinforcement layer configured by metal steel cords, and is covered by rubber.

Rim strip rubber 32 is provided at the inner side in the tire-radial direction of the steel chafer 31. This rim strip rubber 32 is arranged along the outer surface of the tire, and connects with the side wall rubber 30. This rim strip rubber 32 and side wall rubber 30 are rubber members constituting the outer surface of the tire.

Then, at the outer side in the tire-radial direction of the end part 31A of the steel chafer 31, which is at the outer side in the tire-width direction of the folding part 25 of the carcass ply 23 and bead filler 22, a first pad 35 is provided. This first pad 35 is provided so as to cover the outer side in the tire-width direction of at least the folding end 25A of the ply folding part 25. The outer side in the tire-radial direction of the first pad 35 is formed so as to taper as approaching the outer side in the tire-radial direction.

Furthermore, a second pad 36 is provided so as to cover the outer side in the tire-width direction of the first pad 35. In more detail, the second pad 36 is provided so as to cover the outer side in the tire-width direction of part of the steel chafer 31, the first pad 35, part of the second bead filler 222, and part of the ply body 24 of the carcass ply 23. Then, the side-wall rubber 30 is arranged at the outer side in the tire-width direction of an outside region in the tire-radial direction of the second pad 36, and the rim strip rubber 32 is arranged at the outer side in the tire-width direction of an inside region in the tire-radial direction of the second pad 36. In other words, the second pad 36 is provided between the first pad 35, etc., and the rim strip rubber 32 and side wall rubber 30, which are members constituting the outer surface of the tire.

Herein, the first pad 35 and second pad 36 are configured by rubber of higher modulus than the modulus of the bead filler (second bead filler 222) to which these members contact. In more detail, the second pad 36 is configured by rubber of higher modulus than the second bead filler 222, and the first pad 35 is configured by rubber of even higher modulus than the second pad 36. The first pad 35 and second pad 36 have a function of mitigating sudden distortion caused by the local rigidity point of change at the folding end 25A of the carcass ply 23 and the end part 31A of the steel chafer 31.

At the inner side in the tire-width direction of the first pad 35, a rubber sheet 37 is arranged in the vicinity of the folding end 25A of the ply folding part 25. The rubber sheet 37 is arranged so as to cover at least the folding end 25A of the ply folding part 25 from the inner side in the tire-width direction.

Generally, at the folding end 25A of the ply folding part 25, stress tends to concentrate. However, by providing the aforementioned first pad 35 and second pad 36, and further arranging the rubber sheet 37, it becomes possible to effective suppress the concentration of stress.

Herein, an RFID tag 40 is embedded as an electrical component in the tire 1 of the present embodiment.

The RFID tag 40 is a passive transponder equipped with an RFID chip and an antenna for performing communication with external equipment, and performs wireless communication with a reader (not illustrated) serving as the external equipment. As the antenna, a coil-shaped spring antenna, plate-shaped antenna, and various types of rod-shaped antennas can be used. For example, it may be an antenna formed by printing a predetermined pattern on a flexible substrate. The antenna is established at an antenna length optimized according to the frequency band, etc. to be used. In a storage part inside the RFID chip, identification information such as a manufacturing number and part number is stored.

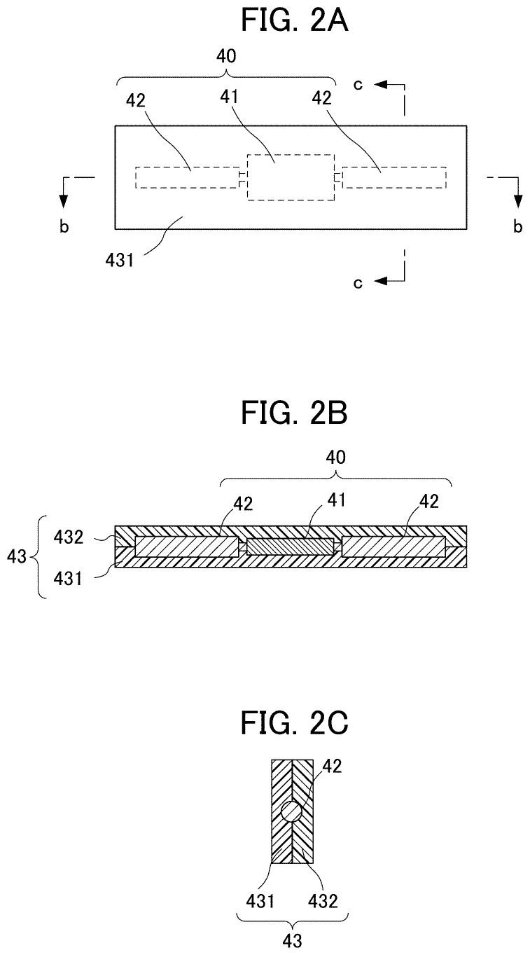

More specifically, FIG. 2A is a view showing an example of the RFID tag 40 of the present embodiment, covered by the protective member 43 configured from a rubber sheet. In FIG. 2A, the RFID tag 40 is covered by the rubber sheet 431 described later to be hidden. FIG. 2B is a cross-sectional view along the line b-b in FIG. 2A, and FIG. 2C is a cross-sectional view along the line c-c in FIG. 2A.

In the present embodiment, as shown in FIG. 2A to 2C, the RFID tag 40 is covered by the protective member 43.

The RFID tag 40 includes an RFID chip 41 and antenna 42 for performing communication with external equipment. As the antenna 42, a coil-shaped spring antenna, plate-shaped antenna, and various types of rod-shaped antennas can be used. For example, it may be an antenna formed by printing a predetermined pattern on a flexible substrate. When considering the communicability and flexibility, a coil-shaped spring antenna is the most preferable.

The protective member 43 is configured from two rubber sheets 431, 432 which protect by sandwiching the RFID tag 40.

The protective member 43 is configured by rubber of a predetermined modulus, for example. Herein, the modulus indicates 100% elongation modulus (M100) under a 23° C. atmosphere, measured in accordance with “3.7 stress at a given elongation, S” of JIS K6251:2010.

As the rubber adopted in the protective member 43, rubber at least having a higher modulus than the side wall rubber 30 is used.

For example, with the modulus of the side wall rubber 30 as a reference, rubber of a modulus 1.1 to 1.8 times may be used as the rubber used in the protective member 43.

In addition, the protective member 43 may be configured from a short-fiber filler mixed rubber. As the short-fiber filler, for example, it is possible to use insulating short fibers like organic short fibers such as aramid short fibers and cellulose short fibers; inorganic short fibers such as ceramic short fibers as in alumina short fiber, and glass short fiber. By mixing such short-fiber fillers into rubber, it is possible to raise the strength of the rubber. In addition, as the protective member 43, a rubber sheet in the vulcanized state may be used. The rubber sheet in a vulcanized state does not plastically deform as raw rubber, and thus can appropriately protect the RFID tag 40. In addition, as the protective member 43, an organic fiber layer from polyester fibers or polyamide fibers may be provided. It is also possible to embed an organic fiber layer in the two rubber sheets 431, 432.

In this way, if configuring the protective member 43 by two rubber sheets, since it is possible to thinly form the RFID tag 40 including the protective member 43, it is favorable upon embedding in the tire 1. In addition, when assembling the RFID tag 40 in the constitutional members of the tires 1 to 3 prior to vulcanization, the RFID tag 40 covered by the rubber sheets can be installed very easily. For example, it is possible to suitably paste the RFID tag 40 covered by the rubber sheet at a desired position of a member such as the first bead filler 221 and second bead filler 222 prior to vulcanization, using the adhesiveness of raw rubber. In addition, by also establishing the rubber sheet as raw rubber prior to vulcanization, it is possible to more simply paste also using the adhesiveness of the rubber sheet itself. However, the protective member 43 is not limited to the form configured by two rubber sheets, and can adopt various forms. For example, the rubber sheet constituting the protective member, so long as covering at least part of the RFID tag 40, can obtain effects such as an improvement in workability in the manufacturing process and stress mitigation. In addition, for example, it may be a configuration wrapping one rubber sheet around the entire circumference of the RFID tag 40, or a configuration attaching the protective member in the form of a potting agent of high viscosity along the entire circumference of the RFID tag 40. Even if such a configuration, it will be possible to appropriately protect the RFID tag 40.

Then, in the tire 1 of the present embodiment, the RFID tag 40 is embedded in the tread rubber 28, as shown in FIG. 1.

In addition, the RFID tag 40 is embedded at a position overlapping in the tire-radial direction with the main groove 12a which extends in the circumferential direction of the tread rubber 28. In other words, the RFID tag 40 is arranged at a position overlapping a projection area in a case of projecting the main groove 12a extending in the circumferential direction of the tread rubber 28 inside the tread rubber 28 from the outer side in the tire-radial direction.

Furthermore, in the present embodiment, as shown in FIG. 1, the RFID tag 40 is arranged at the interface between the tread base 28a and tread cap 28b of the tread rubber 28.

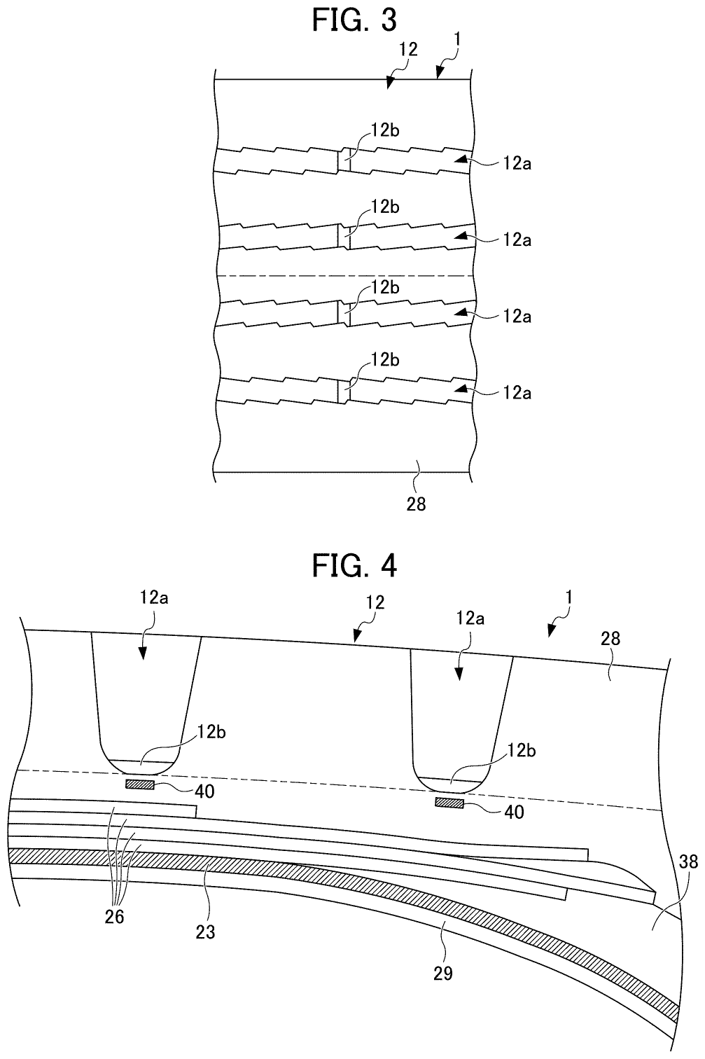

Alternatively, as shown in FIGS. 3 and 4, the RFID tag 40 is arranged so as to overlap in the tire-radial direction with the T.W.I (tread wear indicator: protrusion provided in main groove) 12 provided to the groove bottom of the main groove 12a. It should be noted that FIG. 3 is a half section facing the tread pattern of the tire 1, and FIG. 4 is a cross-sectional view of the tire of FIG. 3 (similar cross-sectional view as FIG. 1).

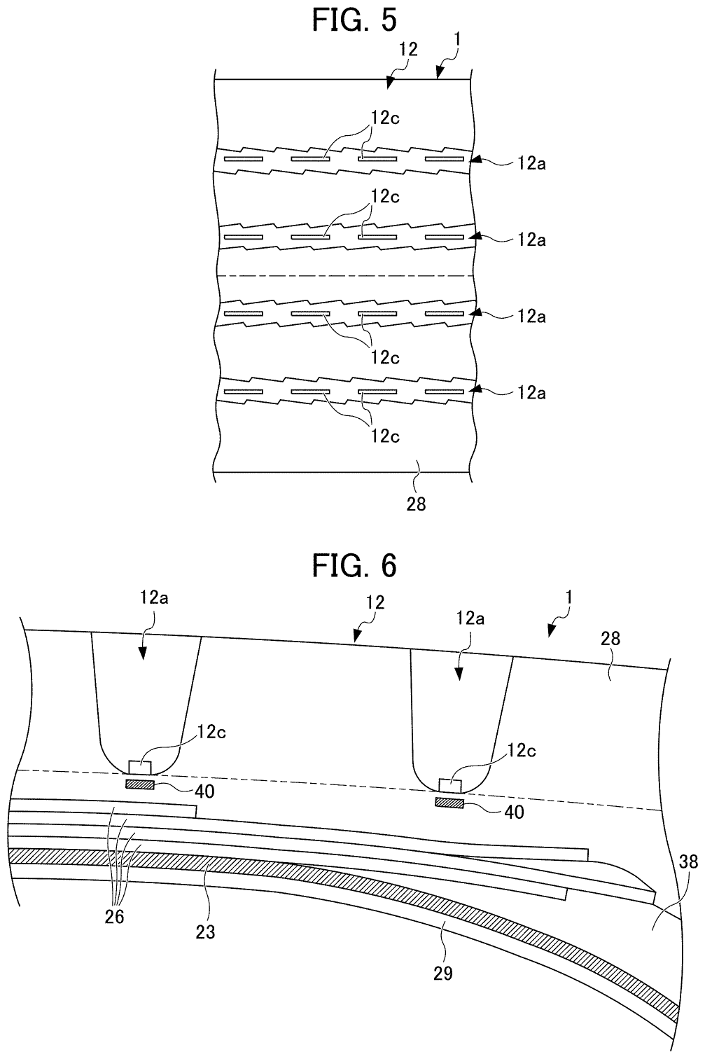

Alternatively, as shown in FIGS. 5 and 6, the RFID tag 40 is arranged within a projection surface of a stone ejector (protrusion provided to main groove) 12c provided to the groove bottom of the main groove 12a. In other words, it is arranged so as to overlap in the tire-radial direction with the stone ejector (protrusion provided to main groove) 12c provided to the groove bottom of the main groove 12a. FIG. 5 is a half section facing the tread pattern of the tire 1, and FIG. 6 is a cross-sectional view of the tire in FIG. 5 (similar cross-sectional view as FIG. 1).

Then, first, as shown in FIG. 1, by the RFID tag 40 being arranged so as to overlap in the tire-radial direction with the main groove (tread) 12a of the tread pattern, compared with the tire tread part making pressure contact with the road surface of the tread 12, a great load does not act on the RFID tag 40, and thus it becomes possible to raise the durability of the RFID tag 40.

In addition, by the RFID tag 40 being arranged at the interface 28c between the tread base 28a and tread cap 28b of the tread rubber 28, it is possible to further raise the durability of the RFID tag 40, without great warping occurring by the tread base 28a of hard rubber.

Next, as shown in FIGS. 3 and 4, and FIGS. 5 and 6, in the case of the RFID tag 40 being arranged so as to overlap in the tire-radial direction with a protrusion such as the T.W.I. (tread wear indicator) 12b or stone ejector 12c provided at the groove bottom of the main groove 12a, similarly to as described above, it becomes possible to raise the durability of the RFID tag 40 due to great load not acting on the RFID tag 40, more than a case of embedding at a portion overlapping in the tire-radial direction with the tire tread part which makes pressure contact with the road surface of the tread 12. Furthermore, since the distance from the exterior of the RFID tag 40 becomes shorter by the main groove 12a, maintaining of the reception distance also becomes easy, and it becomes possible to favorably maintain the communication performance.

On the other hand, by the RFID tag 40 being provided by overlapping in the tire-radial direction with the protrusions 12b, 12c provided to the main groove 12a, the occurrence of warping is small, and it is possible to suppress the load acting on the RFID tag 40 to be small, and thus it becomes possible to raise the durability of the RFID tag 40 more reliably, while maintaining the communication performance. In particular, in the case of the RFID tag 40 being provided to overlap in the tire-radial direction with the stone ejector 12c, since a foreign substance such as a stone is inhibited from getting caught in the main groove 12a, it is possible to prevent a great load from a foreign substance caught in the main groove 12a from acting on the RFID tag 40, and thus it becomes possible to more favorably raise the durability of the RFID tag 40.

It should be noted that, in the present embodiment, although the RFID tag 40 is embedded in the tire 1 as an electronic component, the electronic component embedded in the tire 1 is not limited to an RFID tag. For example, it may be various electronic components such as a sensor which carries out wireless communication. In addition, since the electronic component handles electrical information such as sending and receiving of electrical signals, there is a possibility of the performance declining due to metal components being present in the vicinity thereof. In addition, there is a possibility of the electronic component being damaged by excessive stress being applied. Consequently, even in the case of embedding various electronic components in a tire, it is possible to obtain the effects of the present invention. For example, the electronic component may be a piezoelectric element or strain sensor.

According to the tire 1 of the present embodiment, the following effects are exerted.

(1) In the tire 1 according to the present embodiment, the RFID tag 40 which is an electronic component is embedded at a position overlapping in the tire-radial direction with the main groove 12a extending in the circumferential direction of the annular tread rubber 28, which extends in the circumferential direction of the tire. By configuring in this way, since a great load will not act on the RFID tag 40 as much as a case of embedding at a position overlapping in the tire-radial direction with the tire tread part making pressure contact with the road surface of the tread 12, and since great warping also will not occur due to this, it becomes possible to raise the durability of the RFID tag 40. In addition, since the distance from the exterior of the RFID tag 40 becomes shorter by the main groove 12a, maintaining of the reception distance also becomes easy, and it becomes possible to favorably maintain the communication performance.

(2) In the tire 1 according to the present embodiment, the RFID tag 40 which is an electronic component is arranged at the interface 28c between the tread base 28a and tread cap 28b constituting the tread rubber 28. It thereby becomes possible to maintain the communication performance by shortening the distance until the main groove 12a, while maintaining the durability at the tread base 28a which is hard and thus has relatively small warping.

(3) In the tire 1 according to the present embodiment, the electronic component is embedded in the tread rubber 28 so as to overlap in the tire-radial direction with the protrusions 12b, 12c provided at the groove bottom of the main groove 12a. As the protrusion, for example, the tread wear indicator 12b, stone ejector 12c, etc. can be exemplified. By configuring in this way, similarly to as described above, since a great load will not act on the RFID tag 40 as much as a case of embedding at a portion overlapping in the tire-radial direction with the tire tread part which makes pressure contact with the road surface of the tread 12, it becomes possible to raise the durability of the RFID tag 40. Furthermore, since the distance from the exterior of the RFIG tag 40 becomes shorter by way of the main groove 12a, maintaining of the reception distance also becomes easy, and thus it becomes possible to maintain the communication performance favorably.

In addition to this, by the RFID tag 40 being provided by overlapping in the tire-radial direction with the protrusions 12b, 12c provided to the main groove 12a, the occurrence of warping is small, and it is possible to suppress the load acting on the RFID tag 40 to be small, and thus it becomes possible to raise the durability of the RFID tag 40 more reliably, while maintaining the communication performance. In particular, in the case of the RFID tag 40 being provided to overlap in the tire-radial direction with the stone ejector 12c, since a foreign substance such as a stone is inhibited from getting caught in the main groove 12a, it is possible to prevent a great load from a foreign substance caught in the main groove 12a from acting on the RFID tag 40, and thus it becomes possible to more favorably raise the durability of the RFID tag 40.

It should be noted that, although the tire of the present invention can be adopted as various types of tires such as for cars, light trucks, trucks and buses, it is particularly suitable as a tire of a truck, bus, etc. It should be noted that the present invention is not to be limited to the above-mentioned embodiments, and that even when carrying out modifications, improvements, etc. within a scope capable of achieving the object of the present invention, it is encompassed by the scope of the present invention.

What is claimed is:

1. A tire comprising: an electronic component embedded in the tire,
wherein the electronic component is embedded at a position overlapping, in a tire-radial direction, with a main groove extending in a circumferential direction of an annular tread rubber, which extends in a circumferential direction of the tire.

2. The tire according to claim 1, wherein the electronic component is disposed at an interface between a tread cap and a tread base constituting the tread rubber.

3. The tire according to claim 1, wherein the electronic component is embedded in the tread rubber so as to overlap in a tire-radial direction with a protrusion provided at a groove bottom of the main groove.
